(19) United States
(12) Patent Application Publication
(10) Pub. No.: US 2026/0361983 A1
(43) Pub. Date: Nov. 12, 2026

(54) CAMERA ASSEMBLY

(71) Applicant: Luxshare Intelligent Manufacture Technology (Changshu) Co.,Ltd, Changshu City (CN)

(72) Inventors: Chenyu YU, Changshu City (CN); Chiatan HUANG, Changshu City (CN); Qiqing RUAN, Changshu City (CN); Shiping LIN, Changshu City (CN); Wenyen HUANG, Changshu City (CN); WeiLin HSU, Changshu City (CN)

(73) Assignee: Luxshare Intelligent Manufacture Technology (Changshu) Co.,Ltd, Changshu City (CN)

(21) Appl. No.: 19/384,163

(22) Filed: Nov. 10, 2025

(30) Foreign Application Priority Data
May 9, 2025 (CN) 202510600172.0

(51) Int. Cl. H04N 23/54; G03B 13/36; H04N 23/51; H04N 23/52; H04N 23/55

(52) U.S. Cl. CPC H04N 23/54; G03B 13/36; H04N 23/51; H04N 23/52; H04N 23/55

(57) ABSTRACT

A camera assembly includes a base assembly, a housing, a lens assembly, a carrier, an image sensor and a drive module, where the base assembly includes a base and a fixing member, and the fixing member is integrally arranged on the base and located on a side of the base; an accommodation cavity is formed between the housing and the base assembly; the carrier is slidably arranged within the accommodation cavity; the carrier is provided with a first sliding groove, the fixing member is provided with a second sliding groove, and a guide member is mounted between the first sliding groove and the second sliding groove; an upper end of the first sliding groove is provided with a first limit member and a lower end of the second sliding groove is provided with a second limit member for blocking the guide member from sliding out.

### CROSS-REFERENCE TO RELATED APPLICATIONS

This application claims priority to Chinese Patent Application No. 202510600172.0 filed May 9, 2025, the disclosure of which is incorporated herein by reference in its entirety.

### TECHNICAL FIELD

The present disclosure relates to the field of camera devices and for example, to a camera assembly.

### BACKGROUND

A voice coil motor (VCM) offers advantages such as a simple structure, a compact volume, low power consumption, high acceleration, fast response, precise displacement and a low price so the voice coil motor is still a highly competitive solution for the autofocus function in camera devices.

An existing camera assembly generally includes a base assembly, a housing, a carrier, a lens assembly and a VCM drive module. The base assembly includes a base and a fixing member, and the base and the fixing member are designed as split components. The base provides a lower stroke stop for the carrier. The fixing member carries a coil, a circuit board and the like, and an upper stroke stop of the carrier is arranged on the top end of the fixing member.

### SUMMARY

An embodiment of the present disclosure adopts the following solution. A camera assembly is provided. The camera assembly includes a base assembly, a housing, a lens assembly, a carrier, an image sensor and a drive module.

The base assembly includes a base and a fixing member. The fixing member is integrally arranged on the base and located on a side of the base.

The housing is connected to the base assembly. An accommodation cavity is formed between the housing and the base assembly, and the housing is provided with a central opening.

The lens assembly is fixed within the central opening of the housing.

The carrier is slidably arranged within the accommodation cavity in a first direction.

The image sensor is fixed to a side of the carrier close to the base assembly. The lens assembly is coaxially arranged with the image sensor.

The drive module includes a magnet assembly and a coil assembly. The magnet assembly is arranged on a side of the carrier, and the coil assembly is fixed within the accommodation cavity and arranged opposite the magnet assembly.

A first sliding groove is arranged on a side of the carrier close to the fixing member, and a second sliding groove is arranged on a side of the fixing member close to the carrier. A guide member is mounted between the first sliding groove and the second sliding groove to enable the carrier to be slidably connected to the fixing member. An upper end of the first sliding groove is provided with a first limit member and a lower end of the second sliding groove is provided with a second limit member, and the first limit member and the second limit member are configured to block the guide member from sliding out of between the first sliding groove and the second sliding groove.

### BRIEF DESCRIPTION OF DRAWINGS

FIG. 1 is a structure view of a camera assembly according to Embodiment one of the present disclosure;

FIG. 2 is a structure view of the camera assembly with a housing and a lens assembly removed according to Embodiment one of the present disclosure;

FIG. 3 is an exploded view of the camera assembly according to Embodiment one of the present disclosure;

FIG. 4 is an exploded view of a carrier and a magnet assembly according to Embodiment one of the present disclosure;

FIG. 5 is an exploded view of a base assembly, a coil assembly and a guide member according to Embodiment one of the present disclosure;

FIG. 6 is a first-angle structure view of the base assembly according to Embodiment one of the present disclosure;

FIG. 7 is a second-angle structure view of the base assembly according to Embodiment one of the present disclosure;

FIG. 8 is a structure view of the carrier according to Embodiment one of the present disclosure;

FIG. 9 is a first-angle structure view of a coil and a coil support plate according to Embodiment one of the present disclosure;

FIG. 10 is a second-angle structure view of the coil and the coil support plate according to Embodiment one of the present disclosure;

FIG. 11 is a structure view of the coil according to Embodiment one of the present disclosure;

FIG. 12 is a structure view of the coil support plate according to Embodiment one of the present disclosure;

FIG. 13 is a structure view of a carrier and a metal cover body assembled with each other according to Embodiment two of the present disclosure;

FIG. 14 is an exploded view of the carrier and the metal cover body assembled with each other according to Embodiment two of the present disclosure;

FIG. 15 is a flowchart of a molding process according to Embodiment two of the present disclosure;

FIG. 16 is a structure view of a metal plate having a preset shape according to Embodiment two of the present disclosure; and

FIG. 17 is a structure view of the metal plate processed by a bending process according to Embodiment two of the present disclosure.

### DETAILED DESCRIPTION

The present disclosure is further described in detail below in conjunction with drawings and embodiments. It is to be understood that the embodiments described herein are intended to illustrate the present disclosure and not to limit the present disclosure. Additionally, it is to be noted that for ease of description, only part, not all, of structures related to the present disclosure are illustrated in the drawings.

In the description of the present disclosure, the terms "joined", "connected" and "fixed" are to be understood in a broad sense unless otherwise expressly specified and limited. For example, the term "connected" may refer to "fixedly connected", "detachably connected" or "integrated", may refer to "mechanically connected" or "electrically connected", or may refer to "connected directly", "connected indirectly through an intermediary", "connected inside two components" or "interactional between two components". For those of ordinary skill in the art, specific meanings of the preceding terms in the present disclosure may be understood according to specific situations.

In the present disclosure, unless otherwise expressly specified and limited, when a first feature is described as "above" or "below" a second feature, the first feature and the second feature may be in direct contact or may be in contact via another feature between the two features. Moreover, when the first feature is described as "on", "above" or "over" the second feature, the first feature is right on, above or over the second feature, the first feature is obliquely on, above or over the second feature, or the first feature is simply at a higher level than the second feature. When the first feature is described as "under", "below" or "underneath" the second feature, the first feature is right under, below or underneath the second feature, the first feature is obliquely under, below or underneath the second feature, or the first feature is simply at a lower level than the second feature.

In the description of the present disclosure, orientations or position relations indicated by terms such as "above", "below", "left" and "right" are based on the drawings. These orientations or position relations are intended only to facilitate the description and simplify an operation and not to indicate or imply that an apparatus or element referred to must have such particular orientations or must be configured or operated in such particular orientations. Therefore, these orientations or position relations are not to be construed as limiting the present disclosure. Moreover, the terms "first" and "second" are only used for distinguishing between descriptions and have no special meanings.

Due to the above structure mentioned in the background, an extra step is required to assemble the base and the fixing member during the assembly of the camera assembly; the perpendicularity of the fixing member may become unstable when the fixing member is assembled with the base; in addition, the upper stroke stop arranged on the top end of the fixing member complicates the assembly of the carrier. The embodiments of the present disclosure provide a camera assembly, and the camera assembly can be applied to an electronic product and achieve the autofocus function or the optical anti-vibration function of a lens under the driving of a voice coil motor.

### Embodiment one

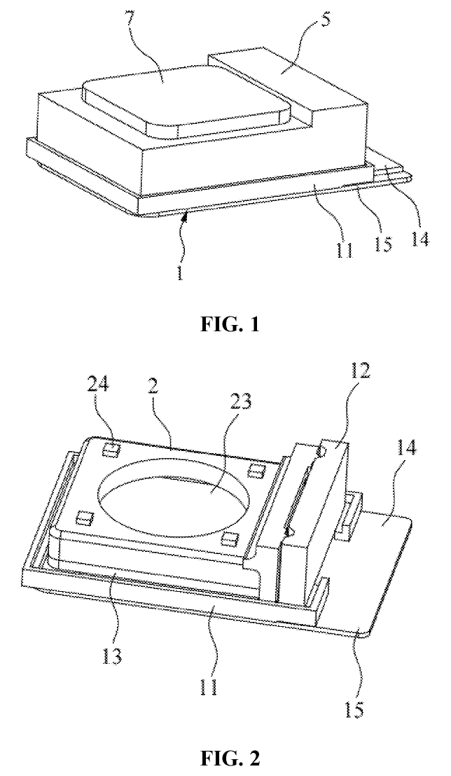

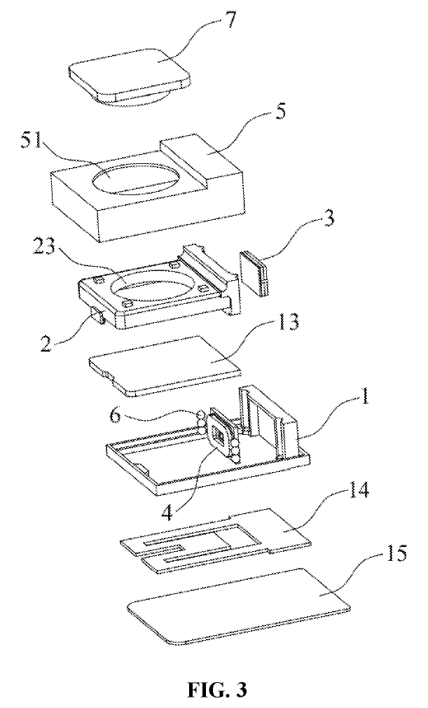

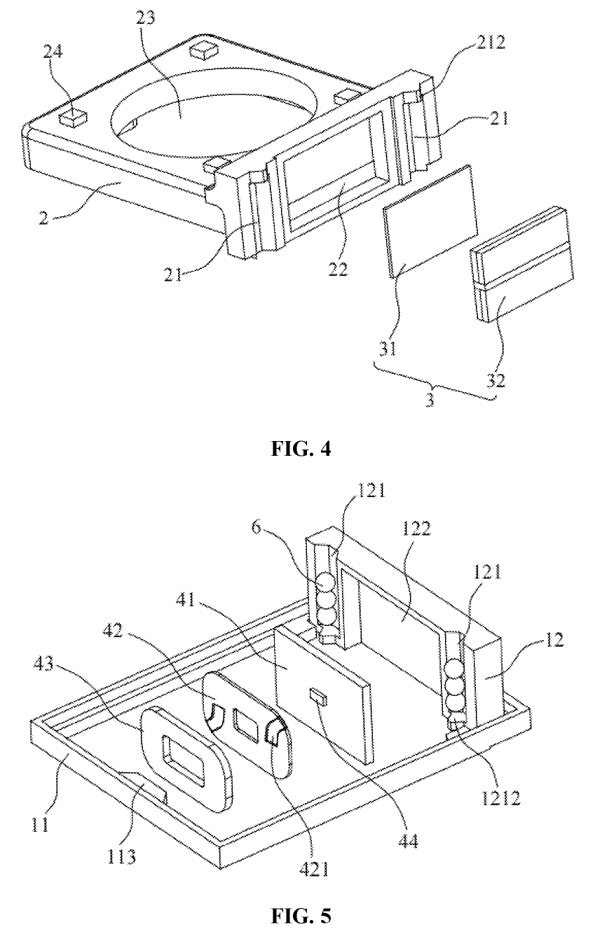

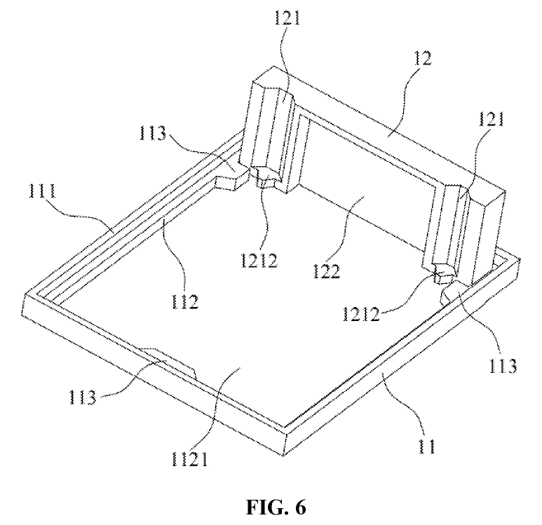

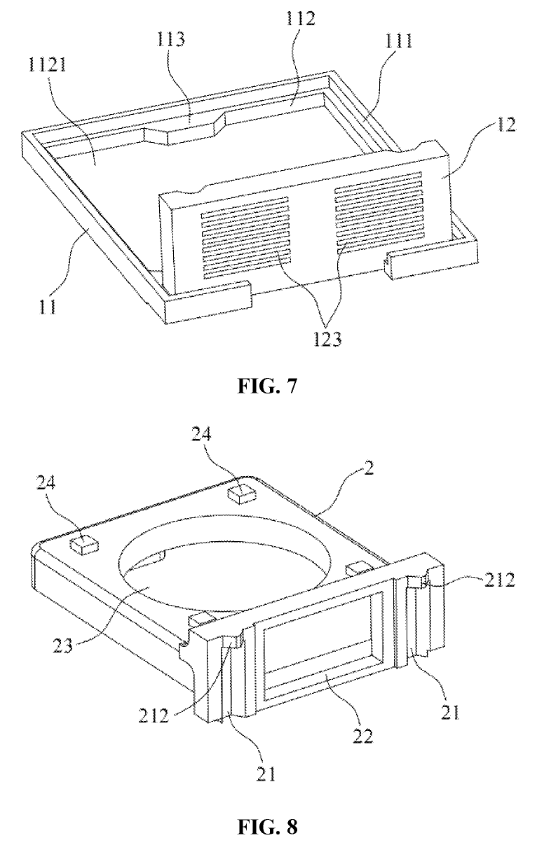

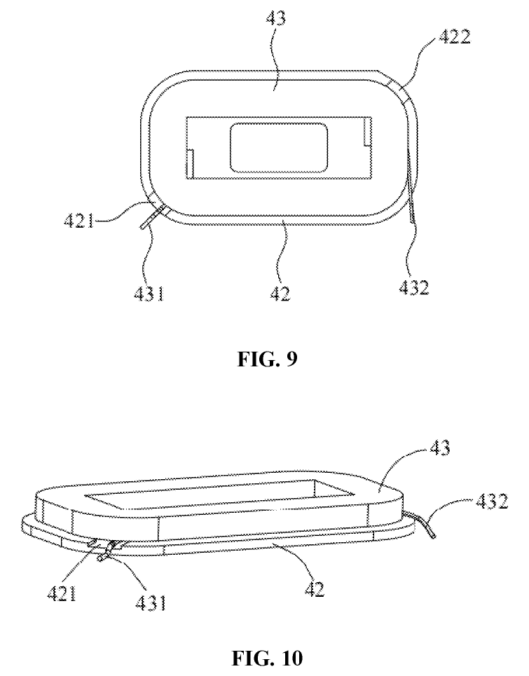

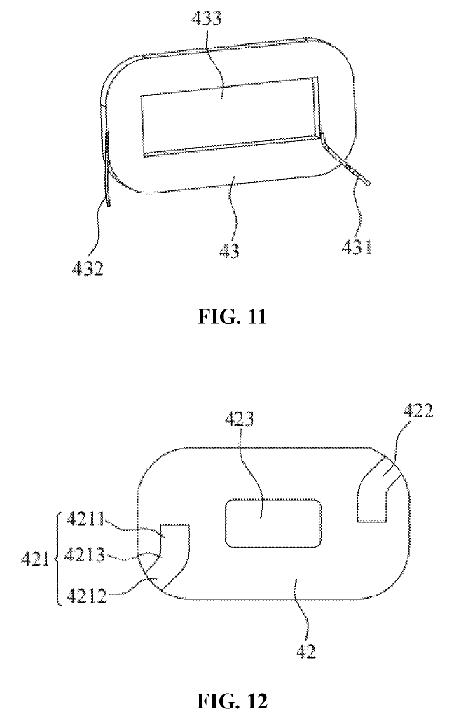

As shown in FIGS. 1-12, this embodiment provides a camera assembly. The camera assembly includes a base assembly 1, a carrier 2, a housing 5, a lens assembly 7, an image sensor 13 and a drive module. The base assembly 1 includes a base 11 and a fixing member 12. The fixing member 12 is integrally arranged on the base 11 and located on a side of the base 11. Preferably, the fixing member 12 is arranged perpendicular to the base 11. The housing 5 is connected to the base 11, and an accommodation cavity is formed between the housing 5 and the base assembly 1. The housing 5 is provided with a central opening 51. The size of the central opening 51 is adapted to the size of the lens assembly 7, and the lens assembly 7 is fixed within the central opening 51. The carrier 2 is slidably arranged within the accommodation cavity in a first direction. The first direction is specifically the optical axis direction of the lens assembly 7. The image sensor 13 is located within the accommodation cavity and fixed to a side of the carrier 2 close to the base 11. The lens assembly 7 is coaxially arranged with the image sensor 13. The carrier 2 is capable of moving with the image sensor 13 in the optical axis direction within the accommodation cavity to change the distance between the image sensor 13 and the lens assembly 7, thereby adjusting the focus of the lens. The image sensor 13 may be a charge-coupled device (CCD) or a complementary metal–oxide–semiconductor (CMOS) sensor, and an image projected on the image sensor 13 may be captured, stored and/or presented to a user. Further, the carrier 2 is a ring structure. A moving through-hole 23 is arranged at the center of the carrier 2, and the moving through-hole 23 longitudinally penetrates the carrier 2. The image sensor 13 is located below the moving through-hole 23, and the lens assembly 7 is located above the moving through-hole 23 so that the light may pass through the moving through-hole 23 and the lens assembly 7 and then reach the image sensor 13, thereby obtaining an image. Moreover, the outer diameter of the lens assembly 7 is smaller than the aperture of the moving through-hole 23 so that the lens assembly 7 may smoothly pass through the moving through-hole 23 when the carrier 2 moves with the image sensor 13.

The base assembly 1 in this embodiment adopts an integrated structure and is manufactured by an integrated molding process, thereby improving the structural strength, reducing the number of components, and lowering the cost. Moreover, the step of assembling the base 11 and the fixing member 12 is omitted, thereby reducing the assembly difficulty, reducing the assembly error, improving the positioning precision between the carrier 2 and the housing 5, and avoiding the uncertainty during the assembly process. In addition, the perpendicularity between the fixing member 12 and the base 11 is guaranteed, thereby avoiding the instability of the perpendicularity between the fixing member 12 and the base 11 when the split structure is adopted and increasing the product robustness.

In this embodiment, by directly fixing the lens assembly 7 within the central opening 51 of the housing 5, the light directly passes through the lens assembly 7 and reaches the image sensor 13, thereby ensuring that the normal passage of the light is not hindered under any circumstances. In this embodiment, by fixing the housing 5 and the lens assembly 7, the assembly precision can be guaranteed simply by ensuring that the image sensor 13 is coaxial with the optical axis of the lens assembly 7 during assembly, thereby facilitating the optimization of the assembly process. The lens assembly 7 may specifically include one or more lenses that may interact to focus the light onto the image sensor 13.

In this embodiment, the drive module is used for driving the image sensor 13. The drive module includes a magnet assembly 3 and a coil assembly 4. The magnet assembly 3 is arranged on a side of the carrier 2 close to the fixing member 12, and the coil assembly 4 is arranged on a side of the fixing member 12 close to the carrier 2. The coil assembly 4 and the magnet assembly 3 are arranged opposite each other. Due to the close proximity between the magnet assembly 3 and the coil assembly 4, the coil assembly 4 may be energized with a current to generate a magnetic field that interacts with the magnetic field of the magnet assembly 3. The attractive force between the magnetic fields drives the carrier 2 and the image sensor 13 to move upward or downward along the optical axis within the accommodation cavity to adjust the distance between the image sensor 13 and the lens assembly 7, thereby achieving the autofocus function.

The drive module in this embodiment further includes a baseplate 15 and a driver circuit 14. The baseplate 15 is fixed below the base 11, and the driver circuit 14 is mounted on the baseplate 15. The driver circuit 14 is electrically coupled to the image sensor 13 and the coil assembly 4 separately. The driver circuit 14 such as a driver integrated circuit (IC) delivers power to the coil assembly 4 to energize the coil assembly 4 to generate a second magnetic field that interacts with the magnetic field of the magnet assembly 3. The driver IC may energize the coil assembly 4 in response to a control signal provided for the driver IC by an external controller such as a microprocessor or other data processing devices. In some embodiments, the driver IC may adjust the magnetic field generated by the coil assembly 4 to drive the carrier 2 to move upward or downward to a precise location. For example, the amount of the attractive force between the magnet assembly 3 and the coil assembly 4 is adjusted by reversing the direction of the current delivered to the coil assembly 4 (thereby reversing the polarity of the magnetic field generated by the coil assembly 4) so that the image sensor 13 is driven by the magnet assembly 3 to move upward or downward through the carrier 2. The image sensor 13 may feed back and transmit the detected image information to a control module or the like of the camera device through the driver circuit 14. Further, the driver circuit 14 also has an elastic function and thus can help the image sensor 13 to be reset after movement and at the same time, enable the image sensor 13 to move upward or downward more stably.

Optionally, a first sliding groove 21 is arranged on a side of the carrier 2 opposite the fixing member 12, and a second sliding groove 121 is arranged on a side of the fixing member 12 opposite the carrier 2. The first sliding groove 21 and the second sliding groove 121 both extend in the optical axis direction of the lens assembly 7. A guide member 6 is mounted between the first sliding groove 21 and the second sliding groove 121 to enable the carrier 2 to slide relative to the fixing member 12. Therefore, the movement smoothness and the movement precision of the carrier 2 in the optical axis direction are increased, and the frictional resistance is reduced. Specifically, the guide member 6 may be multiple balls or a guide column extending in the optical axis direction, which both can provide a good guide function. Preferably, the guide member 6 in this embodiment performs guidance by using balls.

Since the base assembly 1 in this embodiment is an integrated structure, the carrier 2 needs to be assembled onto the base assembly 1 from the top of the base assembly 1, and if a limit member is arranged on the upper end of the second sliding groove 121 of the fixing member 12, the assembly of the carrier 2 may be interfered, thereby affecting the assembly of the carrier 2. To solve the above problem, in this embodiment, the upper end of the first sliding groove 21 of the carrier 2 is provided with a first limit member 212 and the lower end of the second sliding groove 121 is provided with a second limit member 1212; and the first limit member 212 and second limit member 1212 are configured to block the guide member 6 from sliding out of between the first sliding groove 21 and the second sliding groove 121. Therefore, the interference in the assembly of the carrier 2 is avoided to facilitate the smooth mounting of the carrier 2, thereby reducing the assembly difficulty and increasing the product robustness.

The housing 5 in this embodiment is a housing structure with an opening on the lower side. The housing 5 is snap fit over the base 11, and the carrier 2, the fixing member 12, the image sensor 13, the magnet assembly 3 and the coil assembly 4 are all accommodated within the accommodation cavity, thereby achieving a good protective effect on the internal components through the housing 5. Preferably, the material of the housing 5 is metal, and the shape of the housing 5 is a quadrilateral shell having an open lower end. Specifically, the housing 5 may be manufactured with a metal material through processes such as punching and bending. The housing 5 made of a metal material protects the camera assembly from electromagnetic interference (EMI) that may occur in the environment.

Preferably, the housing 5 and the fixing member 12 in this embodiment are fixed by adhesive bonding, and such an assembly manner is simple and makes the connection reliable. Since the surface of the fixing member 12 is generally smooth in the existing art, the adhesive is hardly adhered to the surface of the fixing member 12, thereby affecting the adhesive bonding of the housing 5 to the fixing member 12. To solve the above problem, in this embodiment, a surface (that is, the outer side surface) on a side of the fixing member 12 facing away from the carrier 2 is provided with an indentation structure 123 so that when the adhesive is applied to the outer side surface of the fixing member 12, the adhesive may be adhered to the indentation structure 123, thereby achieving the reliable adhesive bonding of the outer side surface of the fixing member 12 to the inner wall of the housing 5.

Specifically, the indentation structure 123 includes multiple elongated recesses, and each recess extends in the horizontal direction so that the adhesive may be better adhered to the outer side surface of the fixing member 12. Further, the multiple elongated recesses are evenly arranged in an array on the outer side surface of the fixing member 12 to increase the balance of the adhesive bonding to the housing 5. In this embodiment, the adhesive is preferably a glue.

The base 11 in this embodiment includes a bottom frame 112 and a side frame 111 arranged on the bottom frame 112, and the fixing member 12 is integrally arranged within the bottom frame 112. The bottom surface of the housing 5 may be adhesively connected to the bottom frame 112, and the side frame 111 surrounds the periphery of the housing 5. The manner of connecting the housing 5 to the base 11 makes the connection firmer. Meanwhile, the base 11 may provide a more precise mounting location for the housing 5 to enable the lens assembly 7 on the housing 5 to be quickly coaxial with the image sensor 13 in the optical axis direction. The bottom frame 112 has a mounting opening 1121 at the middle location. The size of the mounting opening 1121 is smaller than the inner size of the side frame 111 so that the bottom frame 112 with a certain width may be exposed to receive the housing 5, thereby reducing the manufacturing difficulty and increasing the product stability. Moreover, the mounting opening 1121 may enable the coil assembly 4 to be electrically connected to the driver circuit 14.

The base 11 further includes a limit block 113. One end of the limit block 113 is connected to the inner side surface of the bottom frame 112, and the other end of the limit block 113 extends toward the interior of the mounting opening 1121. The limit block 113 is used for receiving the carrier 2 to prevent the carrier 2 from moving out of the accommodation cavity. The limit block 113 may restrict the downward movement of the carrier 2, and when the carrier 2 moves to the lowermost location, the bottom surface of the carrier 2 abuts against the upper surface of the limit block 113.

Optionally, the upper surface of the limit block 113 may be higher than the upper surface of the bottom frame 112. The area of the limit block 113 is small, and the flatness of the limit block 113 is thus easier to control so that when the carrier 2 is in contact with the limit block 113, the image sensor 13 may still be coaxial with the optical axis of the lens assembly 7. Moreover, the above arrangement can also prevent the adhesive from being squeezed to the upper surface of the limit block 113 when the housing 5 is adhesively bonded to the base 11 and from affecting the movement of the carrier 2.

In the existing art, the limit block 113 is only connected to the inner side surface of the bottom frame 112 but is not fixed to other components, the limit block 113 is separated by a certain distance from the fixing member 12, and the area of the limit block 113 is small, thereby causing the limit block 113 to be prone to be bent or even broken when the carrier 2 moves downward and hits the limit block 113.

To solve the above problem, in this embodiment, the inner side surface of the bottom frame 112 is provided with three limit blocks 113. One limit block 113 is located on a side opposite the fixing member 12. The other two limit blocks 113 are symmetrically arranged on both inner sides of the bottom frame 112, and the other two limit blocks 113 extend to both side portions of the fixing member 12 in a one-to-one correspondence and are connected to both side portions of the fixing member 12, respectively. The arrangement of the three limit blocks 113 can improve the balance of the impact force applied by the carrier 2 onto the limit blocks 113 and increase the supporting stability of the carrier 2. By connecting the two limit blocks 113 located on both sides to the fixing member 12, respectively, the structural strength of the limit blocks 113 can be increased. With the lengths of the limit blocks 113 on both sides extending to a certain extent, the areas of the limit blocks 113 are increased, thereby further improving the structural stability and the bending resistance of the limit blocks 113 and preventing the limit blocks 113 from being bent or broken due to the impact of the carrier 2.

Further, a first mounting groove 22 is arranged on the side of the carrier 2 facing the fixing member 12, and the magnet assembly 3 is mounted within the first mounting groove 22. Optionally, the magnet assembly 3 includes a shielding plate 31 and at least one magnet 32, and each magnet 32 is fixed on the shielding plate 31 by adhesive bonding. All the magnets 32 are combined to form a magnet surface facing the coil assembly 4. Optionally, in this embodiment, one magnet 32 is arranged, and the magnet 32 has a magnet surface facing the coil assembly 4. A second mounting groove 122 is arranged on the side of the fixing member 12 facing the carrier 2, and the coil assembly 4 is mounted within the second mounting groove 122 and arranged opposite the magnet assembly 3.

The coil assembly 4 in this embodiment includes a circuit board 41, a coil support plate 42, a coil 43 and a magnetic sensor 44. The circuit board 41, the coil support plate 42 and the coil 43 are mounted in sequence within the second mounting groove 122 of the fixing member 12 from a location away from the magnet assembly 3 to a location close to the magnet assembly 3. The coil 43 is fixed on the coil support plate 42 (for example, by adhesive bonding) and electrically connected to the circuit board 41, thereby supplying the coil 43 with a control signal, a drive current and the like through the circuit board 41. The magnetic sensor 44 is located in the middle of the coil 43 and electrically connected to the circuit board 41. The magnetic sensor 44 is used for inducing a change in the magnetic field. The circuit board 41 in this embodiment may be a flexible circuit board, a rigid circuit board or a rigid-flex circuit board. When the circuit board 41 is a flexible circuit board, a reinforcement plate may also be provided to increase the strength of the flexible circuit board.

The coil 43 is generally wound by a copper-clad wire. After the coil 43 is manufactured by winding, a first guide wire 431 is drawn from the inner side of the coil 43, a second guide wire 432 is drawn from the outer side, and both the first guide wire 431 and the second guide wire 432 are electrically connected to the circuit board 41. When the coil assembly 4 is to be assembled, the first guide wire 431 located on the inner side of the coil 43 needs to pass laterally outward, and thus the first guide wire 431 is sandwiched between the end surface of the coil 43 and the coil support plate 42. Therefore, the first guide wire 431 and the coil support plate 42 may interfere with each other, and the first guide wire 431 may be excessively crushed and even broken, thereby affecting the normal operation of the camera assembly.

To solve the above problem, in this embodiment, a surface of the coil support plate 42 facing the coil 43 is provided with a first accommodation groove 421 penetrating the edge of the coil support plate 42 to accommodate the first guide wire 431 extending laterally outward from the inner side of the coil 43, and the first guide wire 431 passes out of the first accommodation groove 421 and is electrically connected to the circuit board 41, thereby preventing the first guide wire 431 and the coil support plate 42 from interfering with each other, greatly reducing the risk of the first guide wire 431 being crushed or even broken, and ensuring the operation reliability of the camera assembly.

In this embodiment, the outer contour shape of the coil support plate 42 is the same as the outer contour shape of the coil 43, and the outer contour size of the coil support plate 42 is larger than the outer contour size of the coil 43. The coil 43 is wound to form a first central hole 433, the coil support plate 42 is provided with a second central hole 423, and the size of the second central hole 423 is smaller than the size of the first central hole 433. With the above arrangement, the coil 43 may be completely accommodated on the coil support plate 42, thereby making the structure compact and ensuring the operation reliability.

In this embodiment, the coil support plate 42 is made of a metal soft magnetic material which has the characteristics of low coercivity and high magnetic permeability and is easy to magnetize and demagnetize. Specifically, the coil support plate 42 may be made of an iron-silicon alloy, a soft ferrite or the like. When the magnet assembly 3, the carrier 2 and the image sensor 13 move away from their initial locations in the optical axis direction, a certain restoring force existing between the magnet assembly 3 and the coil support plate 42 enables the magnet assembly 3, the carrier 2 and the image sensor 13 to return to their initial locations. To ensure the returning precision of the magnet assembly 3, the carrier 2 and the image sensor 13, in this embodiment, the shape of the coil support plate 42 is preferably a centrally symmetrical shape to enable the magnetic force to be symmetrically applied to the magnet assembly 3. For example, the coil support plate 42 may be circular, oval or rectangular. Further, the surface of the coil support plate 42 facing the coil 43 is further provided with a second accommodation groove 422, and the structure of the second accommodation groove 422 is the same as the structure of the first accommodation groove 421. The second accommodation groove 422 and the first accommodation groove 421 are arranged symmetrically about the center of the coil support plate 42 or rotationally symmetrical about the axis of the second central hole 423, i.e., the second accommodation groove 422 would overlap with the first accommodation groove 421 if the second accommodation groove 422 is rotated 180 degrees about the axis of the second central hole 423. With the above arrangement, the weight of the coil support plate 42 is symmetrically distributed, and the magnetic force is symmetrically applied to the magnet assembly 3, thereby increasing the stability and the precision of the movement of the magnet assembly 3, the carrier 2 and the image sensor 13. Moreover, with the arrangement of the second accommodation groove 422, the weight of the product is also reduced.

The thickness of the coil support plate 42 affects the magnitude of the Lorentz force onto the magnet assembly 3. Specifically, the greater the thickness of the coil support plate 42, the greater the Lorentz force applied to the magnet assembly 3. To provide a sufficient drive force for the magnet assembly 3, the thickness of the coil support plate 42 should not be removed too much during the manufacturing of the first accommodation groove 421 and the second accommodation groove 422. In this embodiment, the depth of the first accommodation groove 421 and the depth of the second accommodation groove 422 are each 20 % to 40 % of the thickness of the coil support plate 42, thereby minimizing the loss of magnetic force while providing appropriate accommodation space for the first guide wire 431. Preferably, the first accommodation groove 421 and the second accommodation groove 422 in this embodiment are manufactured by punching. For ease of manufacturing, the depth of the first accommodation groove 421 and the depth of the second accommodation groove 422 are set to be 30 % of the thickness of the coil support plate 42 in this embodiment, that is, 30 % of the thickness of the coil support plate 42 is removed during manufacturing. It is to be noted that when the thickness of the coil support plate 42 is thick, the depth of the first accommodation groove 421 and the depth of the second accommodation groove 422 may be equal to or greater than the diameter of the first guide wire 431 so that the first guide wire 431 may be completely embedded in the first accommodation groove 421; when the thickness of the coil support plate 42 is not thick, the depth of the first accommodation groove 421 and the depth of the second accommodation groove 422 may be slightly smaller than the diameter of the first guide wire 431, and at this point, the first guide wire 431 is partially accommodated within the first accommodation groove 421, which can also mitigate interference and crushing between the first guide wire 431 and the coil support plate 42.

Further, since the first guide wire 431 may move during the use and the testing of the camera assembly, if the width of the first accommodation groove 421 is set to be the same as the diameter of the first guide wire 431, the two are likely to interfere with each other. Therefore, in this embodiment, the width of the first accommodation groove 421 is larger than the diameter of the first guide wire 431. Preferably, the width of the first accommodation groove 421 is 5 to 10 times the diameter of the first guide wire 431, thereby providing sufficient movement space for the first guide wire 431. To ensure structural symmetry, the width of the second accommodation groove 422 is also 5 to 10 times the diameter of the first guide wire 431, and the width of the second accommodation groove 422 is the same as the width of the first accommodation groove 421.

To better adapt to the actual wiring of the first guide wire 431, in this embodiment, the shape of the first accommodation groove 421 is preferably arc-shaped. Specifically, the first accommodation groove 421 includes a first extension section 4211, a second extension section 4212 and an arched connecting section 4213 connected between the first extension section 4211 and the second extension section 4212. The included angle between the first extension section 4211 and the second extension section 4212 is an obtuse angle, and the second extension section 4212 penetrates the edge of the coil support plate 42. The shape of the second accommodation groove 422 is the same as the shape of the first accommodation groove 421, which is not repeated in this embodiment. Further, the first accommodation groove 421 and the second accommodation groove 422 are arranged at diagonal locations on the coil support plate 42. With the above arrangement, the first guide wire 431 is easily drawn from the first accommodation groove 421 and then connected to the circuit board 41, and the manufacturing of the groove becomes easier. Of course, in other embodiments, the shape of the first accommodation groove 421 may also be linear or broken-line-shaped, which is not limited to this embodiment.

In this embodiment, multiple anti-collision blocks 24 are further arranged on the top portion and/or the side portion of the carrier 2. When the camera assembly is impacted by an external force or violently vibrated, the anti-collision blocks 24 may absorb shocks and dampen vibrations, and meanwhile, the anti-collision blocks 24 may function to limit the movement of the carrier 2 and provide buffering for the carrier 2, thereby reducing the impact force between the carrier 2 and the housing 5 during the movement of the carrier 2 and improving the vibration damping and noise suppression capabilities of the camera assembly. Preferably, the anti-collision blocks 24 are made of an elastic material such as silicone gel, rubber or resin to better absorb the impact force generated by vibrations, thereby protecting the camera assembly from vibrations.

### Embodiment two

This embodiment provides another camera assembly. The structure of the camera assembly is basically the same as the structure of the camera assembly in Embodiment one except that the camera assembly in this embodiment further includes a metal cover body 8.

In the existing art, the image sensor 13 generates substantial heat during operation. However, the carrier 2 carrying the image sensor 13 in the existing camera assemblies is predominantly manufactured using plastic materials. Although plastics have the advantages such as a low cost, lightweight properties and ease of manufacturing, the plastics demonstrate poor thermal conductivity. Due to the poor thermal conductivity of the plastic carrier 2, the heat generated by the image sensor 13 cannot be dissipated in time and effectively, thereby resulting in temperature accumulation around the image sensor 13. The elevated temperature may affect the normal operation of the image sensor 13, degrade the imaging quality (manifested as increased image noise, color distortion and the like), shorten the service lifetime of the image sensor 13, and even damage the entire camera assembly.

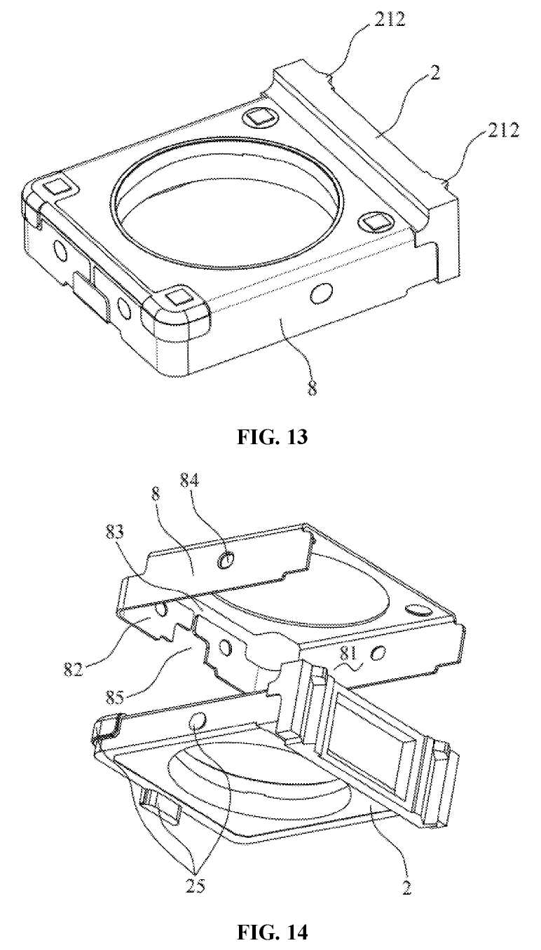

To solve the above problem, as shown in FIGS. 13-14, in this embodiment, the camera assembly further includes a metal cover body 8. The metal cover body 8 is provided with an accommodation groove 81. An elongated hole 83 is arranged at the junction between the groove bottom of the accommodation groove 81 and a first sidewall 82 of the accommodation groove 81. Multiple reinforcement holes 84 are arranged on the sidewall of the accommodation groove 81. The accommodation groove 81 encapsulates the outer wall of the carrier 2. Multiple bosses 25 are arranged on the outer wall of the carrier 2, and the multiple bosses 25 are located within the elongated hole 83 and the multiple reinforcement holes 84. By encapsulating the carrier 2 with the accommodation groove 81 of the metal cover body 8, when the image sensor 13 generates heat, the heat around the image sensor 13 may be dissipated through the carrier 2 and the metal cover body 8. The metal cover body 8 improves the heat dissipation performance of the carrier 2, and the heat generated by the image sensor 13 may be effectively dissipated, thereby improving the performance of the camera assembly. Moreover, by locating the bosses 25 on the outer wall of the carrier 2 within the elongated hole 83 and the reinforcement holes 84, respectively, the assembly strength of the carrier 2 and the metal cover body 8 is improved, and when the camera assembly is used or experiences a drop test, the carrier 2 and the metal cover body 8 are prevented from detachment, thereby improving the reliability of the camera assembly.

Preferably, a notch 85 is arranged on an end of the first sidewall 82 facing away from the groove bottom, and a boss 25 is arranged within the notch 85. After the carrier 2 is connected to the metal cover body 8, the boss 25 within the elongated hole 83 and the boss 25 within the notch 85 abut against both ends of the first sidewall 82 in a first direction, respectively, to restrict the sway of the metal cover body 8 relative to the carrier 2 in the first direction, thereby enhancing the connection strength between the carrier 2 and the metal cover body 8.

In the existing art, the metal cover body 8 is generally manufactured by a stretch-forming process. Before stretch-forming, holes facilitating the stretch-forming process and matching with plastic components are arranged at corners of the accommodation groove 81 of the metal cover body 8. During the stretch-forming process, these holes are prone to damage or deformation and become poor in precision. If the holes become deformed, the strength of the carrier 2 may be compromised, thereby resulting in improper mating engagement between the carrier 2 and the metal cover body 8 and readily causing deformation or fracture of the carrier 2 during testing.

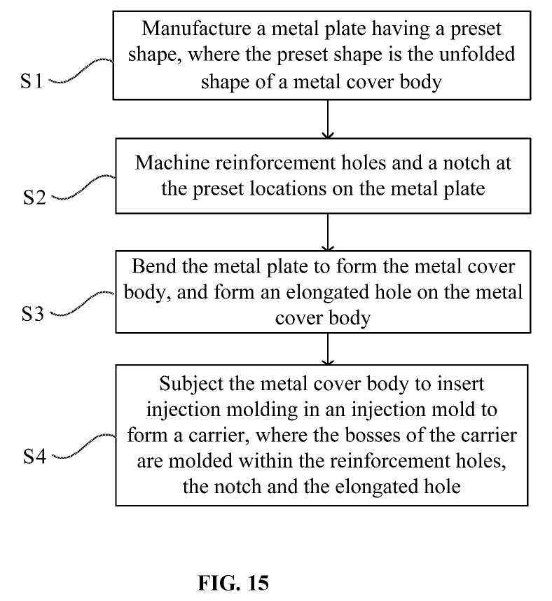

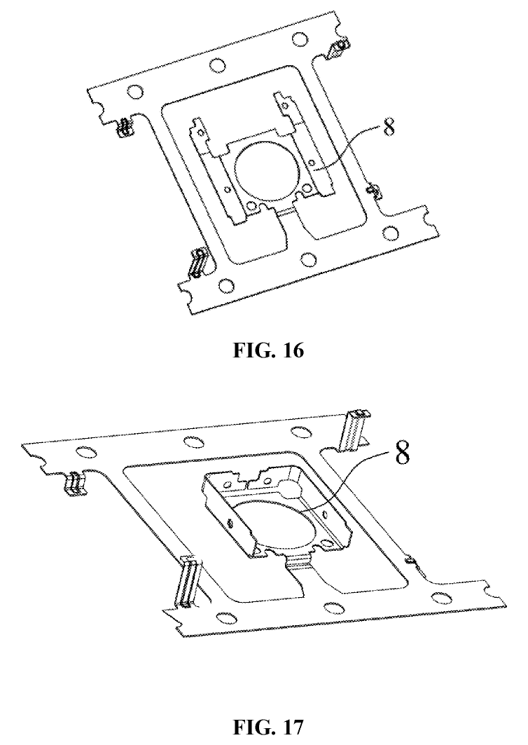

To solve the above problem, as shown in FIGS. 15-17, this embodiment further provides a molding process for manufacturing the carrier 2 and the metal cover body 8 in the camera assembly. The molding process includes the following steps.

In S1, a metal plate having a preset shape is manufactured, where the preset shape is the unfolded shape of the metal cover body 8.

In S2, the reinforcement holes 84 and the notch 85 are machined at the preset locations on the metal plate.

In S3, the metal plate is bent to form the metal cover body 8, and the elongated hole 83 on the metal cover body 8 is formed.

In S4, the metal cover body 8 is subjected to insert injection molding in an injection mold to form the carrier 2, where the bosses 25 of the carrier 2 are molded within the reinforcement holes 84, the notch 85 and the elongated hole 83.

The metal cover body 8 is subjected to hole machining and then molded by a bending process. By molding the metal cover body 8 by a bending process instead of a stretch-forming process, the manufacturing difficulty of the metal cover body 8 is reduced, the precision of the reinforcement holes 84, the notch 85 and the elongated hole 83 is improved, and the probability of product abnormality is lowered. By manufacturing the carrier 2 on the metal cover body 8 by insert injection molding, the connection strength between the metal cover body 8 and the carrier 2 is increased, the metal cover body 8 is prevented from detachment, and the uncertainty during the manufacturing process is reduced. Moreover, the elongated hole 83 with a larger size and higher precision may be formed at the junction between the groove bottom of the accommodation groove 81 and the first sidewall 82 of the accommodation groove 81.

Apparently, the preceding embodiments of the present disclosure are only examples for illustrating the present disclosure clearly and are not intended to limit embodiments of the present disclosure. Those of ordinary skill in the art can make various apparent modifications, adaptations and substitutions without departing from the scope of the present disclosure. There is no need and no way to exhaust all of the embodiments here.

What is claimed is:

1. A camera assembly, comprising:
a base assembly, comprising a base and a fixing member, wherein the fixing member is integrally arranged on the base and located on a side of the base;
a housing, connected to the base assembly, wherein an accommodation cavity is formed between the housing and the base assembly, and the housing is provided with a central opening;
a lens assembly, fixed within the central opening of the housing;
a carrier, slidably arranged within the accommodation cavity in a first direction;
an image sensor, fixed to a side of the carrier close to the base assembly, wherein the lens assembly is coaxially arranged with the image sensor; and
a drive module, comprising a magnet assembly and a coil assembly, wherein the magnet assembly is arranged on a side of the carrier, and the coil assembly is fixed within the accommodation cavity and arranged opposite the magnet assembly;
wherein a first sliding groove is arranged on a side of the carrier close to the fixing member, a second sliding groove is arranged on a side of the fixing member close to the carrier, and a guide member is mounted between the first sliding groove and the second sliding groove to enable the carrier to be slidably connected to the fixing member; an upper end of the first sliding groove is provided with a first limit member and a lower end of the second sliding groove is provided with a second limit member; and the first limit member and the second limit member are configured to block the guide member from sliding out of between the first sliding groove and the second sliding groove.

2. The camera assembly according to claim 1, wherein the housing and the fixing member are fixed by adhesive bonding.

3. The camera assembly according to claim 2, wherein a surface on a side of the fixing member facing away from the carrier is provided with an indentation structure which is configured to apply an adhesive to be adhesively bonded to an inner sidewall of the housing.

4. The camera assembly according to claim 3, wherein the indentation structure comprises a plurality of recesses extending in a horizontal direction.

5. The camera assembly according to claim 1, wherein the base comprises a side frame extending around a periphery of the housing and a bottom frame having a mounting opening, and the fixing member is integrally arranged within the bottom frame; the base further comprises a limit block, the limit block is connected to an inner side surface of the bottom frame and extends toward an interior of the mounting opening, and a bottom surface of the carrier is in contact with the limit block.

6. The camera assembly according to claim 5, wherein the inner side surface of the bottom frame is provided with three limit blocks; one limit block of the three limit blocks is located on a side opposite the fixing member; the other two limit blocks of the three limit blocks are located on both sides of the bottom frame, and the other two limit blocks are connected to both side portions of the fixing member in a one-to-one correspondence.

7. The camera assembly according to claim 1, wherein the coil assembly comprises a board, a coil support plate and a coil arranged in sequence, the coil is fixed on the coil support plate, and the coil has a first guide wire drawn from an inner side of the coil and a second guide wire drawn from an outer side of the coil; a surface of the coil support plate facing the coil is provided with a first accommodation groove penetrating an edge of the coil support plate, and the first guide wire is configured to pass out of the first accommodation groove and is connected to the board.

8. The camera assembly according to claim 7, wherein an outer contour size of the coil support plate is larger than an outer contour size of the coil; the coil has a first central hole, the coil support plate is provided with a second central hole, and a size of the second central hole is smaller than a size of the first central hole.

9. The camera assembly according to claim 8, wherein the coil support plate is made of a metal soft magnetic material, and a shape of the coil support plate is a centrally symmetrical shape; the surface of the coil support plate facing the coil is further provided with a second accommodation groove, and the first accommodation groove and the second accommodation groove are arranged symmetrically about a center of the coil support plate or rotationally symmetrical about an axis of the second central hole.

10. The camera assembly according to claim 9, wherein a depth of the first accommodation groove and a depth of the second accommodation groove are each 20% to 40% of a thickness of the coil support plate.

11. The camera assembly according to claim 9, wherein a width of the first accommodation groove and a width of the second accommodation groove are each 5 to 10 times a diameter of the first guide wire.

12. The camera assembly according to claim 9, wherein a shape of the first accommodation groove and a shape of the second accommodation groove are both arc-shaped, and the first accommodation groove and the second accommodation groove are arranged at diagonal locations on the coil support plate.

13. The camera assembly according to claim 7, wherein
a first mounting groove is arranged on the side of the carrier close to the fixing member, and the magnet assembly is mounted within the first mounting groove; a second mounting groove is arranged on the side of the fixing member close to the carrier, and the coil assembly is mounted within the second mounting groove.

14. The camera assembly according to claim 7, wherein the carrier comprises a moving through-hole, the moving through-hole longitudinally penetrates the carrier, the image sensor is located below the moving through-hole, the lens assembly is located above the moving through-hole, and an outer diameter of the lens assembly is smaller than an aperture of the moving through-hole.

15. The camera assembly according to claim 7, wherein the coil assembly further comprises a magnetic sensor, and the magnetic sensor is connected to the board.

16. The camera assembly according to claim 7, wherein
the magnet assembly comprises a shielding plate and at least one magnet, and each of the at least one magnet is fixed on the shielding plate.

17. The camera assembly according to claim 7, wherein a first mounting groove is arranged on the side of the carrier close to the fixing member, and the magnet assembly is mounted within the first mounting groove; a second mounting groove is arranged on the side of the fixing member close to the carrier, and the coil assembly is mounted within the second mounting groove; and
the carrier comprises a moving through-hole, the moving through-hole longitudinally penetrates the carrier, the image sensor is located below the moving through-hole, the lens assembly is located above the moving through-hole, and an outer diameter of the lens assembly is smaller than an aperture of the moving through-hole.

18. The camera assembly according to claim 7, wherein
a first mounting groove is arranged on the side of the carrier close to the fixing member, and the magnet assembly is mounted within the first mounting groove; a second mounting groove is arranged on the side of the fixing member close to the carrier, and the coil assembly is mounted within the second mounting groove; and
the coil assembly further comprises a magnetic sensor, and the magnetic sensor is connected to the board.

19. The camera assembly according to claim 7, wherein a first mounting groove is arranged on the side of the carrier close to the fixing member, and the magnet assembly is mounted within the first mounting groove; a second mounting groove is arranged on the side of the fixing member close to the carrier, and the coil assembly is mounted within the second mounting groove; and
the magnet assembly comprises a shielding plate and at least one magnet, and each of the at least one magnet is fixed on the shielding plate.

20. The camera assembly according to claim 1, wherein the drive module further comprises a baseplate and a driver circuit, the baseplate is fixed to the base, the driver circuit is mounted on the baseplate, and the driver circuit is electrically coupled to the image sensor and the coil assembly separately.
